(19) United States
(12) Patent Application Publication
(10) Pub. No.: US 2013/0151986 A1
(43) Pub. Date: Jun. 13, 2013

(54) METHOD FOR RECOMMENDING PERSONAL APPEARANCE

(71) Applicant: Chloe Sinclair Bennett Robinson, San Diego, CA (US)

(72) Inventor: Chloe Sinclair Bennett Robinson, San Diego, CA (US)

(21) Appl. No.: 13/325,020

(22) Filed: Dec. 13, 2011

(51) Int. Cl. G06F 3/01; G06F 15/16

(52) U.S. Cl. 715/751

(57) ABSTRACT

A method is described to give personal appearance recommendations to a user based upon weather, geographic location, age, gender, occasion, and user-selected style preferences.

### FIELD OF THE INVENTION

The present invention describes a method for enabling users to determine the appropriate personal appearance based on a selection of conditions which results in a graphically displayed content of recommendations by users based on weather, geographic location, gender, age, occasion, and style preferences.

### BACKGROUND

There are a variety of ways to help determine which outfit to choose for a particular occasion. One way is simply to watch the weather or check a weather website and then to look through your personal inventory of apparel and accessories and try to assemble an appropriate personal appearance. Another way is to look in magazines for the season's latest fashions. Magazines tend to focus on a particular age group, allowing the reader to purchase a magazine that it right for his or her age. The user can then heed the advice of the magazine, combine that with knowledge of the next day's weather and try to make an outfit that is both stylish, age appropriate, and situationally appropriate.

The use of traditional media such as magazines and newspapers have made recommendations to their readers about what apparel might be considered stylish for a particular season, meaning whether something is in style for the winter or fall, as a time period when something is fashionable. However, magazines are not in a position to say what might be the right apparel specific to the weather that is happening at the moment. Nor are magazines capable of delivering a recommendation that is specific to each particular reader's age, style, and particular circumstance.

Weather websites and channels allow the public to know what the weather is at the moment, as what the weather is likely to be the following day, or a few days out. This information is provided through government sources, and is widely distributed. However, it is imperfect in many ways, including that the weather that is predicted is not always accurate enough to determine one's choice of apparel for the day. What would enhance the results of the weather data is to have actual input from people based on their microclimate, such that a person could see what the predicted weather is as well as what people say about the weather in their specific region or sub region.

The Internet has allowed wider dissemination of both weather data as well as fashion recommendations. The Internet has also allowed consumers to share ideas with one another, share photos of themselves and others, and post comments to each other's photos, posts and comments. People can photo-blog on websites such as Flickr® (registered to Yahoo!), Photobucket® (registered to Photobucket), and more recently Tumblr® (registered to Tumblr), which allows easy upload of photos into a stream, subscription through RSS to the user's posts, and comments to posts and comments, which can also have subscriptions.

While there have been a variety of ways for people to determine what they might wear today, tomorrow, or the following day, they have had to consider various resources, combine different data points, and then make a guess at what might work. Accordingly, there is a need for a method that assists the user in choosing apparel based upon other user recommendations given a set of criteria.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of various exemplary embodiments, a method for assisting a user in making a recommendation for personal appearance, comprising: the user selects a gender, the user selects an occasion, the user selects preferences from a list, the user selects age criteria from a list; storing to a computer memory, by a computer system, the user-selected occasion, preferences, and age criteria; calculating, by the computer system, the age of the user from the user selected age criteria; retrieving, from the computer system, coupled to the computer network, geographical location information for the user; retrieving, from the computer system, coupled to the computer network, the recommendations; and displaying, for the user, the recommendations.

### BRIEF DESCRIPTION OF THE DRAWINGS

The various embodiments can be better understood with reference to the following drawings. Those of skill in the art will understand that the drawings, described below, are for illustrative purposes only and are not intended to limit the scope of the present teachings in any way. Accordingly, other embodiments may be used in addition to or instead of the embodiments presented herein, without departing from the spirit and scope of this disclosure. When the same numeral appears in different drawings, it is intended to refer to the same or like components or steps.

FIG. 1 shows an example of the preferred embodiment from the perspective of the client server, wherein an application program interface (“API”) is installed on a server with a processor, memory, and operating system, providing the API access to the Internet through a network connection.

FIG. 2 shows the recommendation engine and its interaction with the API, the users, the users recommendations, and the weather data.

FIG. 3 shows the flow of information between the recommenders, weather data provider, and the server.

FIG. 4 shows the process of the preferred embodiment in terms providing the user with apparel recommendations based on the user inputs.

### DETAILED DESCRIPTION

In the following detailed descriptions of the preferred embodiments, reference is made to the accompanying drawings that form a part hereof, and in which is shown, by way of illustration, specific embodiments in which the invention may be practiced. It is to be understood that other embodiments may be used in addition to or instead of the embodiments presented herein, without departing from the spirit and scope of the disclosure. When the same numeral appears in different drawings, it is intended to refer to the same or like components or steps.

One preferred embodiment of the present disclosure is directed toward a method of displaying apparel recommendations based on a user's regional expected weather, gender, age and style preferences. In one preferred embodiment, the user can select their gender, age, one or more of a variety of style preferences, and the occasion which become the matrix against which the data is combined with the weather to formulate recommendations. Recommendations can originate with the system administrator, users, and advertisers who program the recommendations to match certain criteria.

In one preferred embodiment, the user can obtain recommendations anonymously, or the user can register and set his/her preferences such that the system automatically recognizes the user and his/her preferences and automatically displays images of apparel and models wearing apparel based on the existing preference settings and the projected weather for that day or the upcoming day(s). Also, users can post comments to the weather status for their region, which enables users to state whether or not the weather forecast is actually accurate given their particular microclimate. In principal, the present invention can include recommendations for any number of days into the future. Additionally, the user can create bookmarks or “favorites” that enables them to easily access recommendations that have been posted so that the user can access them again. Users can share the recommendations that they like via such social networking sites as Facebook® (registered to Facebook) and Twitter® (registered to Twitter), which are fully integrable with the present disclosure.

In one preferred embodiment, the invention permits users to rate or rank recommendations with a rating system like, for example, a five-star system wherein a user selects one to five stars to rate the quality of the recommendation. Also, a ranking system could allow users to rank their favorites. Rating and ranking can be shared with other users in the community and the system can take those recommendations from an aggregate of users and use that data to display most and least popular. User data can also be used to rank and rate the individual users who post recommendations such that their individual reputation increases or decreases. As users make recommendations, the system can allow the administrator to filter the recommendations, sort them, delete, edit, or otherwise handle the recommendations in various workflow states.

In one preferred embodiment, advertisers can post photos, bid on a price that they will pay for each click on a photo or for each impression of the photo's appearance on the system, and manage their various recommendations. Advertisers can view statistical data, engage in analysis of such data and use that date to make their bids. Advertisers can make competitive bids for advertising wherein the highest bidder has their recommendation displayed first in the sequence of recommendations. Advertisers can choose the appropriate matrices for each recommendation such that a recommendation is only displayed for the proper age group, gender, and style selections, under the selected weather conditions and time of year. Users may then purchase the recommendations from within the software application or via a link to the third-party advertiser website.

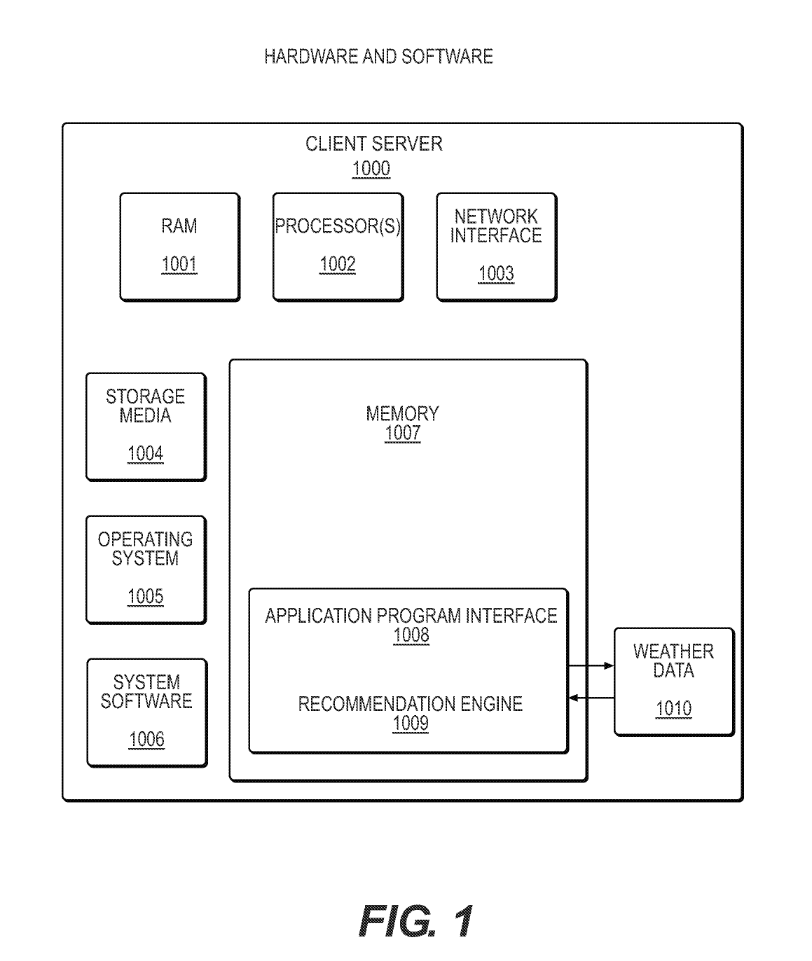

FIG. 1 illustrates one preferred embodiment of the apparel recommendation method. An application program interface (API) 1008 is installed into memory 1007 on a client server 1000, which has random access memory 1001, a processor 1002, a network interface 1003, storage media 1004, operating system 1005, host software applications 1006. The API 1008 uses these server components to operate a recommendation engine 1009 that interacts with users 1020, advertisers 1021, and weather data sources 1010 through a connection to the internet 1003.

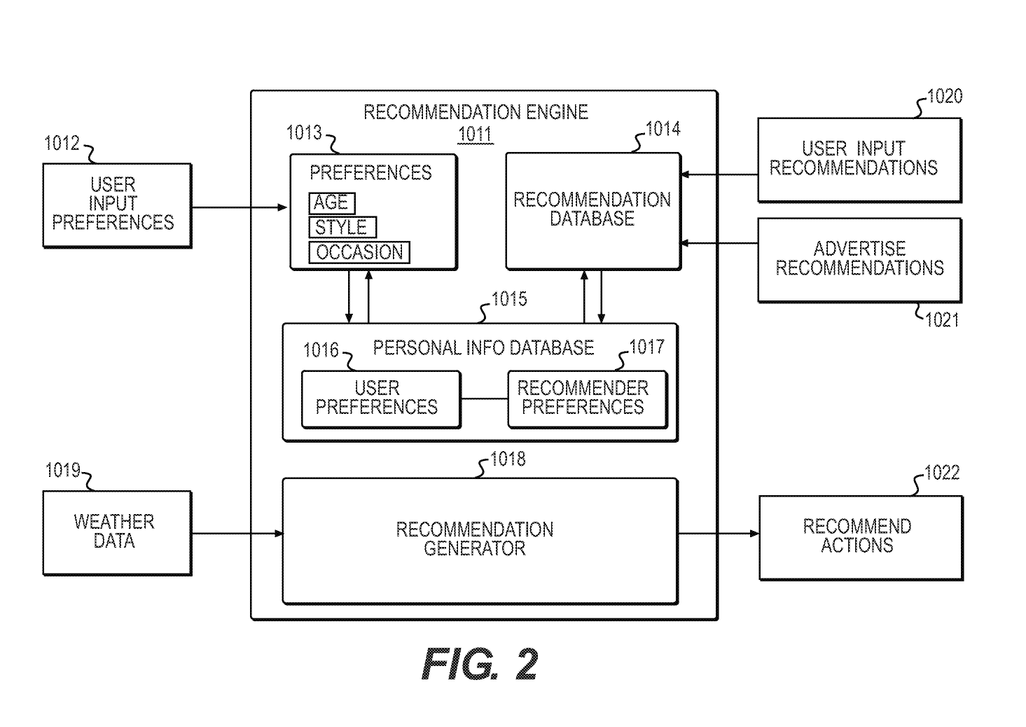

FIG. 2 illustrates one preferred embodiment of the apparel recommendation engine. The apparel recommendation engine 1011 comprises the user selected preferences 1013, the recommendation database 1014, and the personal info database 1015. The user selected preferences include gender, style, age, and occasion. Style preferences may include clothing styles, facial make-up styles, hair-styles, and accessory styles. The personal info database comprises the saved user preferences, saved recommender preferences 1017, and the recommendation generator 1018. After the API 1000 queries the recommendation engine 1011, the recommendation generator 1018 obtains customized weather data 1019 from third party sources on the Internet, and creates recommendations 1022 based on the synthesized user preferences 1016 and saved recommender preferences 1017. The weather data 1019 is specific to the geographic vicinity of the user and can either be user selectable or automatically gathered using the global positioning system or other geographic location means. Users may make recommendations by entering data 1020 into the recommendation engine 1011. Advertisers may make recommendations either by entering data 1021 into the recommendation engine 1011 or entering directly into the API 1000.

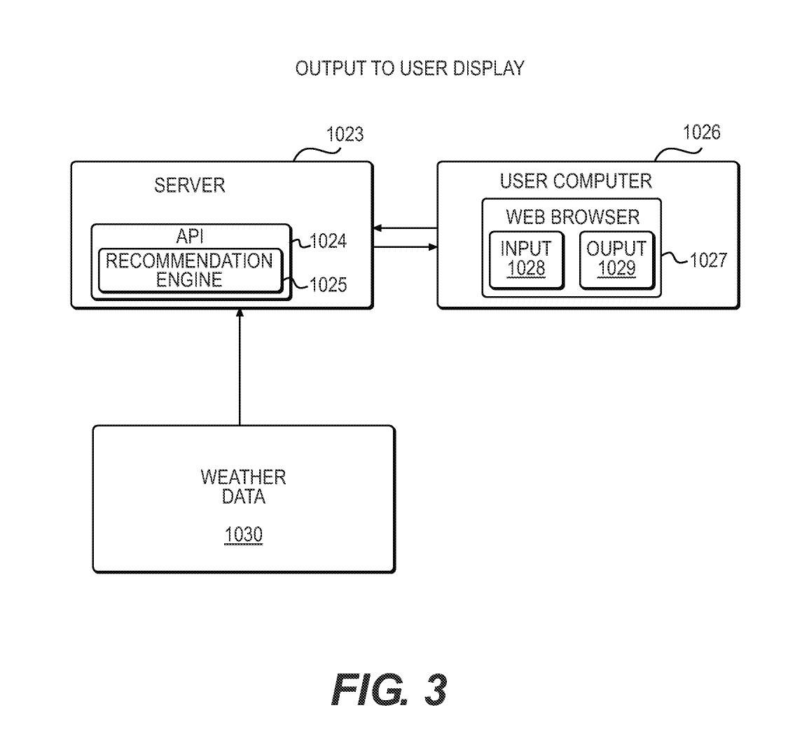

FIG. 3 illustrates one preferred embodiment of the apparel recommendation engine output to user display. After processing is complete, the server 1023 that contains the API 1024 and recommendation engine 1025 displays the recommendations for the user onto the user's computer 1026. The definition of a user's computer is a desktop, laptop, notebook, mobile phone, or any other device with a computer processor and video display.

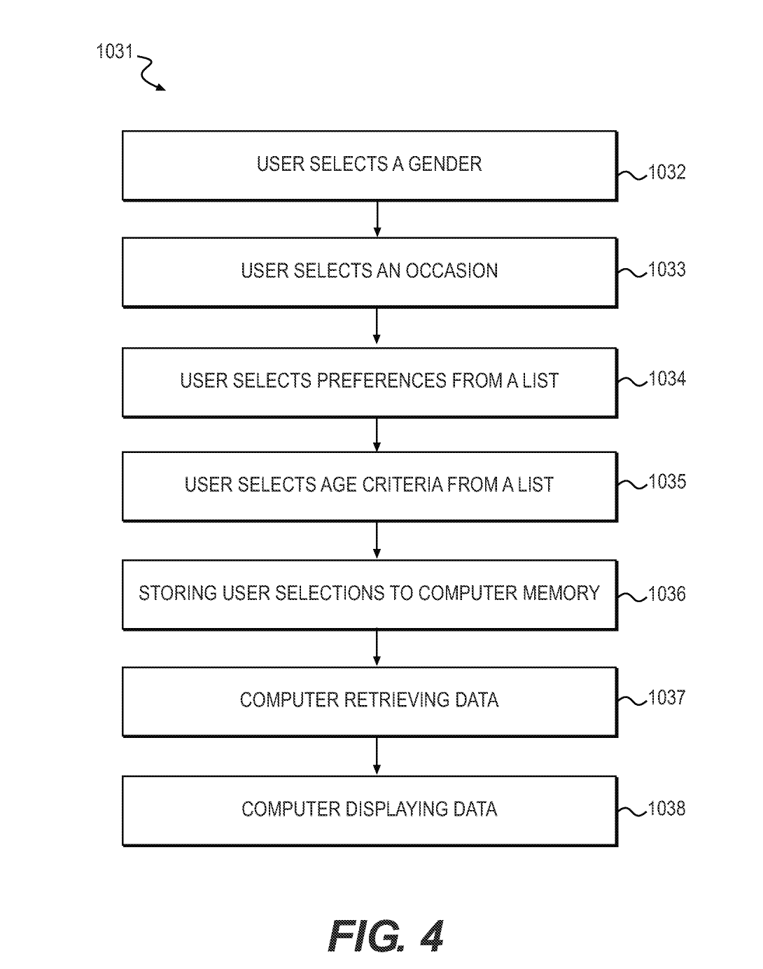

FIG. 4 illustrates one preferred embodiment of the method in which a user receives an apparel recommendation. The method 1031 begins with a user launching the application and inputting parameters. The application will check memory locations 1007 for previously selected user preferences to avoid forcing the user repeat the input process. If there were previously entered user preferences, the application will query the user if they desire to change those preferences or use the existing preference settings. If the user is new to the application or the user desires to modify the preferences, then the user must select a gender 1032, an occasion to which the outfit shall be worn 1033, a style preference 1034, and age criteria 1035. Those preferences and parameters may next be stored into computer memory 1036 for later use. The recommendation engine via a computer processor next retrieves 1037 the weather data, user recommendations, and advertiser recommendations. The recommendation engine via the computer processor then displays 1038 the result after processing the retrieved data. A user may endlessly repeat the cycle with different preferences.

Accordingly, the present invention is a method of enabling users to view recommendations by other users for what might be appropriate to wear apparel, choose make-up, or do their hair, for the weather based on the particular style, age, and occasion selections. This allows style publications, fashion brands, clothing brands, make-up and hair product brands and retailers to put their recommendations into a system that is matched with weather data, occasion, style, gender, and age. Moreover, this method allows community members to upload photos that can become recommendations for others to wear. Members can comment on other member's photos and rate them, such as using a five star rating system or other manner of giving higher rating, as well as improving the reputation of recommenders based on the popularity of their recommendations in the community.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method assisting a user in making a recommendation for a personal appearance, comprising:
(a) the user selects a gender;
(b) the user selects an occasion;
(c) the user selects preferences from a list;
(d) the user selects age criteria from a list;
(e) storing to a computer memory, by a computer system, the user-selected occasion, preferences, and birthdate;
(f) calculating, by the computer system, the age of the user from the user selected age criteria;
(g) retrieving, from the computer system, coupled to the computer network, geographical location information for the user;
(h) retrieving, from the computer system, coupled to the computer network, the recommendations; and
(i) displaying, for the user, the recommendations.

2. The method of claim 1, wherein the user selections that are stored to the computer memory enable the user to skip steps of selected preferences thereafter.

3. The method of claim 1, wherein the recommendations are made by other computer users.

4. The method of claim 1, wherein the recommendations can be commented on by other computer users.

5. The method of claim 1, wherein the recommendations can be tracked by computer users.

6. The method of claim 1, wherein the recommendations can be rated by other computer users.

7. The method of claim 1, wherein the recommendations can be ranked by other computer users.

8. The method of claim 1, wherein the recommendations can be commented on by other computer users.

9. The method of claim 1, wherein the recommendations can be requested by other computer users.

10. The method of claim 1, wherein the recommendations can be stored to computer memory by other computer users.

11. The method of claim 1, wherein the recommendations of computer users can create a reputation for the user who posted the recommendations.

12. The method of claim 1, wherein the style preferences stored to computer memory enable the user to skip the steps of inputting preferences thereafter.

13. The method of claim 1, wherein the recommendations are integrable with other computer software applications.

14. A method of claim 1, wherein the user can make purchases of recommendations without having to exit the software application.

15. A method of claim 1, wherein the user can make purchases of recommendations from a third-party website.

16. A method of claim 1 that employs a searchable database of items, keywords, ranking, brand name, and ratings.

17. A method of claim 1, wherein preferences are clothing style preferences.

18. A method of claim 1, wherein preferences are hair style preferences.

19. A method of claim 1, wherein preferences are facial makeup style preferences.

20. A method of claim 1, wherein preferences are accessory style preferences.
